(19) United States
(12) Patent Application Publication
(10) Pub. No.: US 2026/0055657 A1
(43) Pub. Date: Feb. 26, 2026

(54) SLIDING DOOR SEAL

(71) Applicant: ASSA ABLOY (Schweiz) AG, Richterswil (CH)

(72) Inventors: Andreas BRÄNDLE, Winterthur (CH); Lukas Richard WALTER, Benken (CH)

(73) Assignee: ASSA ABLOY (Schweiz) AG, Richterswil (CH)

(21) Appl. No.: 19/308,466

(22) Filed: Aug. 25, 2025

(30) Foreign Application Priority Data
Aug. 26, 2024 (EP) 24196457.6

(51) Int. Cl. E06B 7/16; E06B 3/46

(52) U.S. Cl. CPC E06B 7/16; E06B 3/4636

(57) ABSTRACT

A sliding door seal for sealing a door gap has a first seal part for fastening to a stationary element (A, E, S) of a sliding door and a second seal part for fastening to a displaceable door wing (F) of the sliding door. The first seal part and the second seal part run parallel to one another and define a longitudinal direction (L). They together form a barrier, in order to close the door gap. The barrier defines a transverse direction (Q). The barrier has at least one self-aligning element which is held movably in a bearing in a guided manner. The sliding door seal according to the invention can be used in a versatile manner and enables friction-free and low-noise actuation of the sliding door seal.

### CROSS-REFERENCE TO RELATED APPLICATIONS

This application claims priority to European Patent Application No. 24196457.6 filed Aug. 26, 2024, the entire contents of which are incorporated herein by reference.

### TECHNICAL FIELD

The present invention relates to a sliding door seal for sealing a door gap of a sliding door, in particular a top door gap.

### PRIOR ART

A seal of a top gap of the sliding door is made more difficult due to its suspension and movement unit.

DE 2 206 186 A discloses a seal for sliding doors which is intended to decrease frictional loads by sliding of the sealing parts on one another in the longitudinal direction being avoided during opening and closing of the door. To this end, the movable door wing is moved in three orthogonal directions during closing. Doors of this type are no longer up-to-date.

EP 1 860 272 A2 proposes arranging a seal with a movable sealing strip in the upper region of a vertical frame part, in order to seal the frame in a horizontal direction with respect to a door leaf of the displaceable door wing. EP 2 366 857 A2 proposes arranging a sealing rail with a movable sealing strip on the running carriage of the displaceable door wing in such a way that the sealing strip likewise moves in the horizontal direction and seals with respect to the door frame.

EP 3 825 503 A1 discloses a sliding door with a sealing strip which can be moved automatically during closing of the door wing, is arranged on an upper end face of the door wing, and seals at the top in the vertical direction.

DE 20 2007 006 127 U1 describes a sliding element of a room partition with a strip-shaped flexible seal which is arranged on the lower side of a sliding body and is inserted into a groove of a rail. An upper seal is not disclosed.

DE 2 302 234 A discloses a sealing apparatus for foldable partition walls in the form of flexible profile strips which are arranged on the movable wall body.

### SUMMARY OF THE INVENTION

It is an object of the invention to provide a sliding door seal which is suitable for sealing a door gap, in particular a top door gap, and which can be used in a versatile manner.

The sliding door seal according to the invention has a first seal part for fastening to a stationary element of a sliding door and a second seal part for arranging on a displaceable door wing of the sliding door. The first seal part and the second seal part run parallel to one another and define a longitudinal direction. The first seal part and the second seal part together form a barrier, in order to close the door gap which is formed between the stationary element and the displaceable door wing. The barrier defines a transverse direction which runs perpendicularly with respect to the longitudinal direction. The barrier has at least one self-aligning or self-compensating element which is held movably in a bearing in a guided manner.

In this text, the term “self-aligning” is used synonymously with “self-compensating”. A self-aligning element adapts to the external conditions thanks to its movability and assumes an optimum position which corresponds to the circumstances.

The transverse direction runs in the surface of the barrier with which the barrier closes the gap. On account of the arrangement, the second seal part can be displaced in the longitudinal direction relative to the first seal part.

Thanks to the self-aligning element, the sliding door seal can be formed with simple components and with a high degree of flexibility for possible designs, without it being necessary for seals with movable sealing strips, i.e. what are known as drop-down seals, to be used. The sliding door seal adapts automatically to the local conditions.

The use of a barrier with at least one self-aligning element avoids undesired noise during opening and closing of the sliding door, and provides optimum light protection.

The sliding door seal according to the invention does not require any triggering mechanism because the barrier forms the required sealing surface in every position of the movable door wing. Nevertheless, the seal is not static, but rather adapts dynamically thanks to the at least one self-aligning element. The sliding door seal according to the invention therefore combines the advantages of an automatic drop-down seal with those of static seals, without acquiring their disadvantages.

The configuration according to the invention of the sliding door seal enables a versatile use of the sliding door seal, in particular in the upper region of the sliding door, and also in the region of the running rail and the running wheel. The sliding door seal does not have to be adapted in each case to a specific configuration of a sliding door system, but rather can be used in the same configuration in different systems. The main elements of the sliding door seal can be supplemented by different components which enable a multiplicity of installation variants. This increases the flexibility and reduces the production costs. In particular, it can also be used in sliding doors which have a soft closing feature.

Furthermore, sliding doors which have already been mounted can also be retrofitted with a sliding door seal of this type.

The sliding door seal is extremely space-saving and can also be used for glass doors.

Thanks to the self-compensation or the self-alignment of the barrier, the production and the mounting are simplified. Furthermore, individual elements of the seal can be replaced more simply.

The barrier with the self-aligning element minimizes the forces which are to be applied during displacement of the door wing, and therefore increases the use comfort.

The sliding door seal can be used to seal the top door gap. Depending on the position of the sliding door seal in the sliding door, it can seal the upper end face of the door wing with respect to a stationary component which is arranged above this end surface, or it can seal a side end surface of the door wing with respect to a stationary element which is arranged to the side of it. If the longitudinal direction of the mounted sliding door seal runs horizontally, it can be used to seal a top or bottom door gap. If the longitudinal direction runs vertically in the installed state, it can be used to seal a vertical door gap.

If the sliding door seal is used to seal the bottom door gap, it can be arranged in a barrier-free manner.

The self-aligning element preferably is at least one sealing strip which runs parallel to the longitudinal direction. A first and a second sealing strip are preferably present which both run parallel to the longitudinal direction, wherein at least one of them is a self-aligning element.

The first sealing strip or the second sealing strip is preferably mounted in the other sealing strip in a floating manner in a direction parallel to the transverse direction and/or parallel to the longitudinal direction. The floating mounting is an optimum means for self-alignment or self-compensation.

Floating mounting has the advantage that, in the case of a mounted sliding door seal, the relative position of the two sealing strips with respect to one another adapts automatically in the vertical and/or in the horizontal, even if, for example, the floor height of the door wing is reset.

The abovementioned advantages apply, in particular, to the embodiments with floating mounting and, in particular, to embodiments in which the sealing strips are mounted in a floating manner in a direction parallel to the transverse direction.

The first and the second sealing strip are preferably together part of the second seal part which can be fastened to the displaceable door wing, or they are together part of the first seal part which is fastened to the stationary sliding door element. The two sealing strips are preferably connected to one another non-displaceably in the longitudinal direction in these cases, but are preferably connected to one another in a floating manner in a direction parallel to the transverse direction.

The sealing strips are preferably longitudinal profiles, wherein they are of identical length. They extend approximately over the entire width of the sliding door wing if they are a constituent part of the displaceable seal part, and they are approximately as long as the running rail if they are a constituent part of the stationary seal part.

In other embodiments, one of the two sealing strips is a constituent part of the first seal part, and the other one of the two sealing strips is a constituent part of the second seal part. In this case, the two sealing strips can be displaced relative to one another in the longitudinal direction thereof. They are preferably still mounted in a floating manner with respect to one another, however. The sealing strip which is arranged on the first seal part preferably has a length which corresponds to the running rail. The other sealing strip preferably has a length which corresponds to the width of the door wing.

The first or the second seal strip preferably has a receiving groove running in the longitudinal direction with a U-shaped or C-shaped cross section, and the other seal strip preferably has a counterpiece running in the longitudinal direction with a matching cross section. The counterpiece is preferably mounted in the groove in a floating manner in the transverse direction and therefore perpendicularly with respect to the longitudinal direction. Other types of floating mounting are possible. Other cross sections of the grooves and the counterpieces are likewise possible. The groove and the counterpiece each preferably extend over the entire length of the respective sealing strip. The groove is preferably of open configuration on both end faces.

The first sealing strip and/or the second sealing strip are/is of flexible or soft configuration in some embodiments. In other embodiments, one sealing strip is of soft or flexible configuration, and the other is of stiff or rigid configuration. Both sealing strips are preferably of stiff or rigid configuration, however. In this text, “rigid” is understood to mean non-movable and non-elastic, and “stiff” is understood to mean non-soft and non-movable but with a very small movability.

At least one of the two sealing strips can preferably be swivelled about an axis which runs parallel to the longitudinal direction. This increases the ease of mounting thanks to further self-compensation or self-alignment, reduces wear by parts which rub against one another, and reduces the operating forces and noise generation for the same reason.

In preferred embodiments, at least one of the sealing strips can be swivelled about an axis which runs parallel to the longitudinal direction. This increases the self-compensation or the self-alignment of the individual elements. Installation tolerances are increased.

In particularly preferred embodiments, the degrees of freedom of the individual components and therefore the self-compensation or self-alignment of the sliding door seal are maximized by it being possible for the first sealing strip and the second sealing strip to be swivelled about in each case one axis which runs parallel to the longitudinal direction.

The swivel capability can be achieved in different ways. It is preferably guided. As an alternative, for example, it can be achieved via a resilient or a flexible connection. In preferred embodiments, the at least one swivellable sealing strip has a swivel body which extends over its entire length, wherein the swivel body preferably has a round cross section. The swivel body is preferably of hollow configuration and it has a groove which is open perpendicularly with respect to the longitudinal direction and parallel to the transverse direction. The swivel body therefore preferably has the shape of a hollow profile which is preferably slotted in the longitudinal direction. The swivel body is preferably connected in one part to a sealing body. The sealing body of the one sealing strip is preferably mounted in a floating manner in the sealing body of the other sealing strip.

In some embodiments, the first and the second sealing strip are fastened directly to the stationary and to the displaceable part of the sliding door, for example by means of screws, an adhesive bond or are held in an articulated manner. In other embodiments, one sealing strip is directly connected, and the other sealing strip is indirectly connected.

The first seal part preferably has a first receiving part which is a constituent part of the sliding door or serves for fastening to the stationary element of the sliding door. The first sealing strip is held in the first receiving part. As an alternative or in addition, the second seal part has a second receiving part which is a constituent part of the sliding door or serves for fastening to the displaceable door wing. The second sealing strip is held in the second receiving part. This simplifies mounting, and the sliding door seal can be mounted, in particular also can be retrofitted, without adaptation of the sliding door.

As has been mentioned, the first and the second receiving part can be separate components which can be fastened on the stationary and on the displaceable part of the sliding door. In other embodiments, the two receiving parts are an integral constituent part of the sliding door, for example by the running rail, the door frame, a wall, a panel or a wall adapter of the sliding door being of corresponding configuration.

The receiving parts are preferably longitudinal profiles, wherein the receiving part which is arranged in a stationary manner is preferably of longer configuration than the displaceable receiving part. It is preferably at least approximately twice as long, with the result that a movement which is guided over the entire displacement path of the sliding door is made possible.

In some embodiments, the sealing strips are connected to the receiving parts in a stiff manner. Preferably, however, the first sealing strip can be positionally changed relative to the first receiving part and/or the second sealing strip can be positionally changed relative to the second receiving part. This results in further degrees of freedom for the adaptation of the sealing strips to the local conditions.

The first sealing strip and/or the second sealing strip are/is preferably mounted in the first and in the second receiving part such that they/it can be swivelled about an axis parallel to the longitudinal direction. The swivel capability in combination with the floating mounting enables an optimum adaptation to the local conditions, and maximizes the self-compensation or self-alignment of the seal apparatus.

The connection between the sealing strip and the receiving part can take place in different ways. In preferred embodiments, the first receiving part has a first connecting body with a first mounting groove for receiving the first sealing strip, and/or the second receiving part has a second connecting body with a second mounting groove for receiving the second sealing strip. The first and the second swivel body are preferably arranged in the first and the second mounting groove, respectively. A first and/or second mounting groove are/is preferably configured with an approximately round cross section, as a result of which the connection enables an optimum swivel capability. One of the two sealing strips can preferably be displaced in the longitudinal direction in its receiving means, and the other cannot. Both can preferably be swivelled in their receiving means, however.

The fastening of the first and/or the second receiving part to the sliding door, if they are not already an integral constituent part of the latter, can take place in different ways. For example, they can be adhesively bonded or screwed on. The receiving parts preferably have a base plate for fastening to one of the stated components of the sliding door, in order to facilitate the fastening.

The sealing strips are preferably manufactured from plastic, aluminium or an elastomer. Depending on the embodiment, they have a coating, for example flocking or another coating which improves the sliding properties. They can also be uncoated, however.

The receiving parts are preferably manufactured from aluminium or plastic.

The sealing strips and/or the receiving parts are preferably each configured in one part.

A sliding door arrangement according to the invention has a sliding door and a sliding door seal according to the invention, wherein the first sealing strip of the sliding door seal is fastened indirectly or directly to a running rail, a door frame, a wall adapter, a panel or a building wall of the sliding door.

### BRIEF DESCRIPTION OF THE DRAWINGS

Preferred embodiments of the invention are described in the following text with reference to the drawings, which serve merely for explanatory purposes and should not be interpreted as limiting. In the drawings:

FIG. 1 shows a diagrammatic perspective illustration of a sliding door with a closed door wing;

FIG. 2 shows the sliding door according to FIG. 1 with an open door wing;

FIG. 3 shows a cross section through an upper region of the sliding door according to FIG. 1 with a sliding door seal according to the invention in a first embodiment;

FIG. 4 shows a perspective exploded illustration of the sliding door seal according to FIG. 3;

FIG. 5 shows an enlarged detail of the sliding door seal according to FIG. 4;

FIG. 6 shows a perspective illustration of the upper region of the sliding door with a sliding door seal according to FIG. 3, without a vertical sealing strip;

FIG. 7 shows the illustration according to FIG. 6 with a vertical sealing strip;

FIG. 8 shows a longitudinal section through an upper region of the sliding door with a sliding door seal according to the invention in a second embodiment;

FIG. 9 shows a longitudinal section through an upper region of the sliding door with a sliding door seal according to the invention in a third embodiment;

FIG. 10 shows a longitudinal section through an upper region of the sliding door with a sliding door seal according to the invention in a fourth embodiment; and

FIG. 11 shows a longitudinal section through an upper region of the sliding door with a sliding door seal according to the invention in a fifth embodiment.

### DESCRIPTION OF PREFERRED EMBODIMENTS

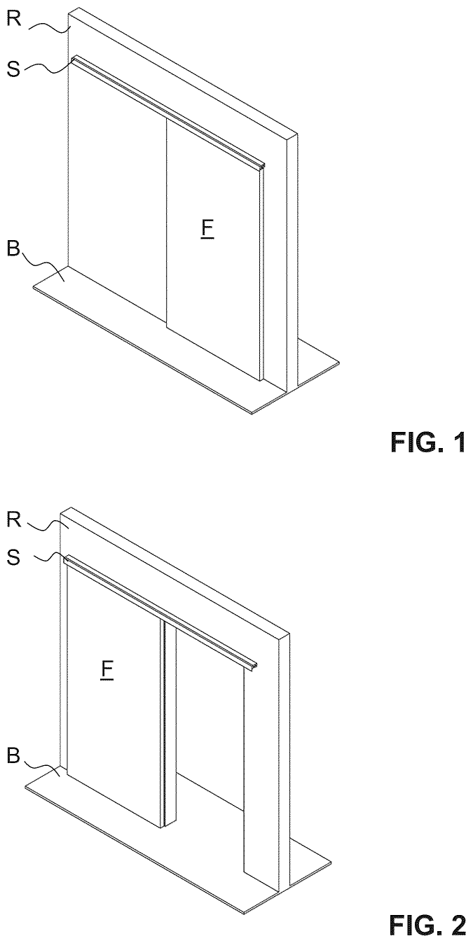

FIGS. 1 and 2 show by way of example a sliding door, with which the sliding door seals according to the invention can be used. A door wing F is held in a door frame R such that it can be displaced in an upper running rail S relative to a stationary part of the sliding door. In this example, the stationary part is formed by the building wall or the frame R. In other embodiments, in particular in the case of glass doors, this is a separate component. The floor is shown diagrammatically in FIGS. 1 and 2 and has the reference sign B.

A first exemplary embodiment of the sliding door seal according to the invention, mounted in a sliding door, can be seen in FIGS. 1 to 7. The door wing F is fastened displaceably in the running rail S via at least one connecting part V and at least one running wheel W which form a running carriage. The running rail S has corresponding grooves for receiving and guiding the running carriage V, W. The connecting part V forms a suspension means for the door wing and preferably has a spindle for setting the floor height, that is to say the spacing of the door wing from the floor.

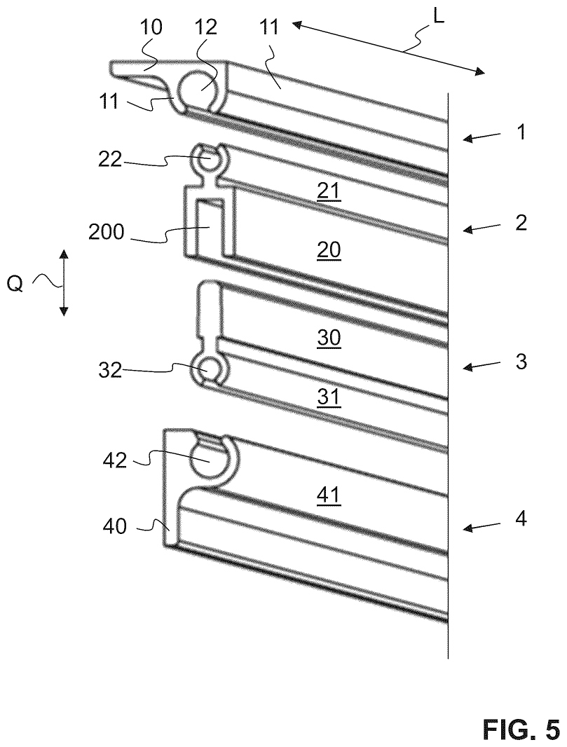

The sliding door seal has a first receiving part 1, a first sealing strip 2, a second sealing strip 3 and a second receiving part 4. The first receiving part 1 is fastened to the stationary part of the sliding door, which here is the running rail S. The second receiving part 2 is fastened to the displaceable part, that is to say the door wing F. To this end, as can be seen in FIG. 5, the two receiving parts 1, 4 have a first and second base plate 10, 40.

The first receiving part 1 has the first base plate 10 which forms a preferably planar surface for fastening to the stationary part of the sliding door. Furthermore, it has a first connecting body 11 which is moulded in one part on the first base plate 10 and forms a first mounting groove 12. The first connecting body 11 is configured as a slotted hollow tube. The first mounting groove 12 has a round cross section. In this example, the first mounting groove 12 is arranged on that side which faces away from the stated surface of the first base plate and enables access perpendicularly with respect to the surface of the first base plate 10. It is therefore of downwardly open configuration in the mounted state, and the base plate 10 is fastened to the downwardly directed side of the stationary part.

The second receiving part 4 has the second base plate 40 which forms a preferably planar surface for fastening to the stationary part of the sliding door. Furthermore, it has a second connecting body 41 which is moulded in one part on the second base plate 40 and forms a second mounting groove 42. The second connecting body 41 is configured as a slotted hollow tube. The second mounting groove 42 has a round cross section. In this example, the second mounting groove 42 is arranged on that side which faces away from the stated surface of the second base plate 40 and enables access parallel to the surface of the second base plate 40. It is therefore of upwardly open configuration in the mounted state, and the second base plate 40 is fastened to a vertical side of the door wing F.

The base plates 10, 40 and the connecting bodies 11, 41 extend over the entire length of the respective receiving parts 1, 4 which are configured as longitudinal profile strips.

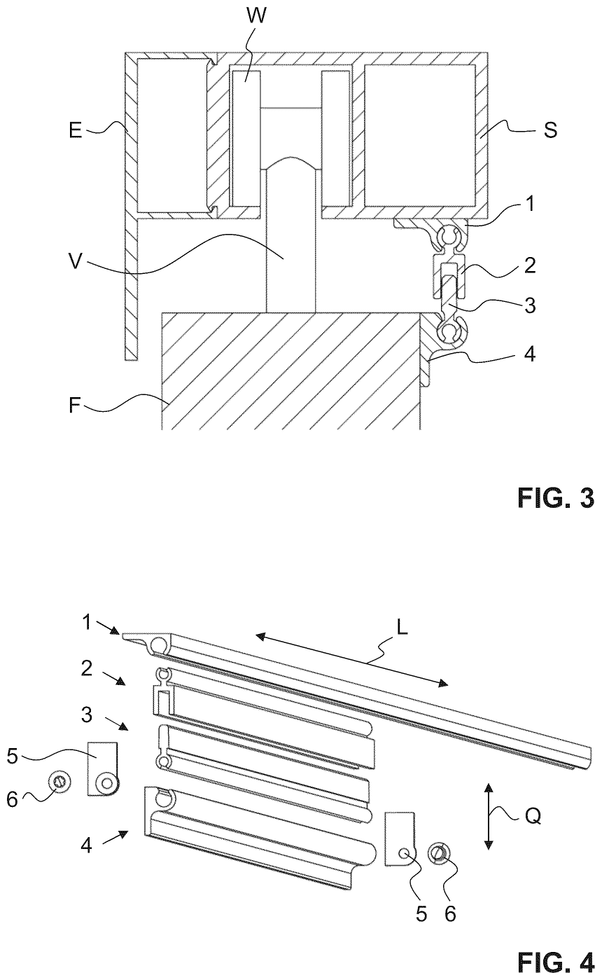

The first sealing strip 2 is held in the first receiving part 1. As can be seen in FIG. 3, it is held, preferably mounted, such that it can be swivelled relative to the latter. The second sealing strip 3 is held in the second receiving part 4. It is likewise held, preferably mounted, such that it can be swivelled relative to the latter.

To this end, the first sealing strip 2 has a first swivel body 21. The first swivel body 21 can be configured as a solid body or, as in this example, as a hollow tube with a round cross section. The first swivel body 21 has a first swivel body groove 22. The first swivel body groove 22 is preferably of upwardly open configuration in the installed state of the seal. The first swivel body 21 is received in the first mounting groove 12. The slotted configuration of the two bodies 11, 21 which can be brought into engagement simplifies the assembly.

The first sealing strip 2 is arranged in the first receiving part 1 such that it can be displaced in the longitudinal direction L of the sliding door seal. It can therefore be swivelled and displaced relative to the first sealing strip 1.

Furthermore, the first sealing strip 2 has a first seal body 20 which is preferably moulded in one part on the first swivel body 21. The first seal body 20 has a U-shaped cross section with two side walls which run parallel to one another and form a receiving groove 200 between them. The receiving groove 200 is of open configuration on the side which is opposite the swivel body 21. It is therefore of downwardly open configuration in the mounted state of the seal.

The second sealing strip 3 has a second swivel body 31. The second swivel body 31 can be configured as a solid body or, as in this example, as a hollow tube with a round cross section. The second swivel body 31 has a second swivel body groove 32. The second swivel body groove 32 is preferably of downwardly open configuration in the installed state of the seal. The second swivel body 31 is received in the second mounting groove 42. The slotted configuration of the two bodies 41, 31 which can be brought into engagement simplifies the assembly.

The second sealing strip 3 is arranged in the second receiving part 4 non-displaceably in the longitudinal direction L of the sliding door seal. It can merely be swivelled. This can be achieved, for example, by corresponding shaping of the swivel body groove and the swivel body. In the embodiment which is shown, covers 5, which are described in the following text and are fixed by way of screws or by way of caps 6 which can be plugged into the groove, serve as stops on both sides. The stops can also be configured in different ways. The stops have the advantage that the second sealing strip 3 can be mounted more simply, since it can be pushed into the receiving part 4. In addition, the two receiving parts 1, 4 can be of identical configuration, such that they can be configured as yard goods and can be selectively combined with one of the two sealing strips. This increases the number of possible mounting variants.

Furthermore, the second sealing strip 3 has a second seal body 30 which is preferably moulded in one part on the second swivel body 31. This second seal body 30 is preferably configured as a solid body. It preferably has a rectangular cross section. At least in the mounted state, it is introduced into the receiving groove 200 of the first sealing strip 2 and is mounted there in a floating manner.

The second sealing strip 3, the second receiving part 4 and the door wing F which is connected to it can therefore be displaced together with the first sealing strip 2 relative to the first receiving means 1 which is mounted in a stationary manner and therefore relative to the running rail S.

A barrier which closes the door gap is configured between the first and the second receiving parts 1, 4, in particular by the first and the second sealing strip 2, 3. This barrier defines a transverse direction Q which runs perpendicularly with respect to the longitudinal direction L. Furthermore, it runs in that surface of the barrier, in particular of the sealing strips 2, 3, which closes the door gap.

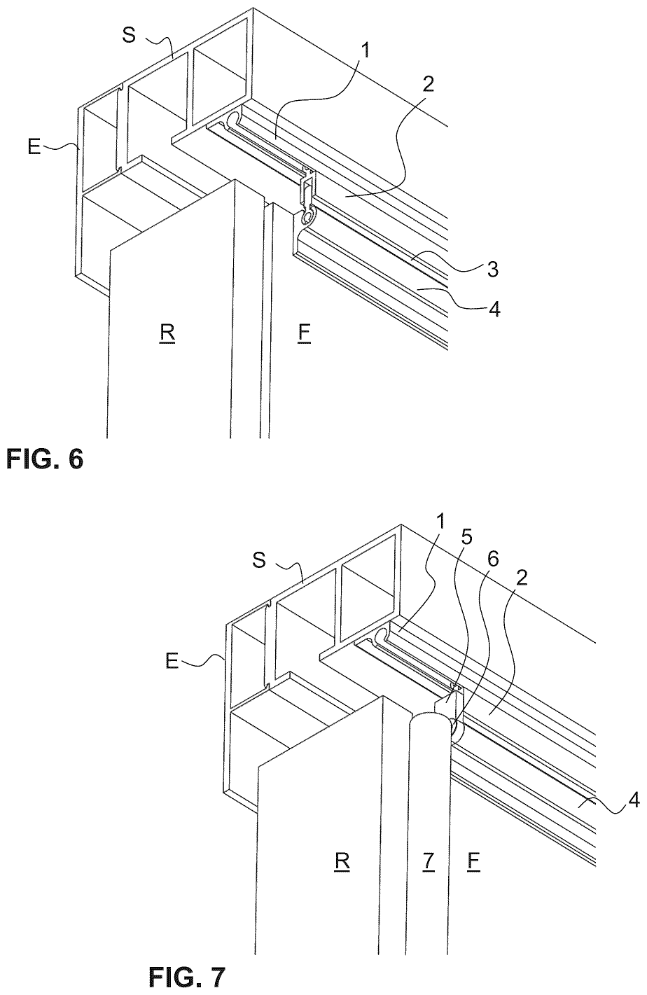

As can be seen in FIG. 6, the first receiving part 1 and therefore the stationary first seal part preferably extend over the entire length of the running rail S. The displaceable second seal part, formed by the first sealing strip 2, the second sealing strip 3 and the second receiving part 4, extends over the width of the door wing, but ends at least on one end face at a spacing from it. This enables the combination of this horizontal seal with a vertical seal, as is shown in the following text.

As can be seen in FIG. 4, the sliding door seal comprises, furthermore, two covers 5 and two caps 6. The covers 5 cover the two end surfaces of the first and second sealing strip 2, 3 and therefore also the first and second mounting groove 12, 42. In some embodiments, there is merely at least one cap 6, but no cover 5. The at least one cap 6 which preferably consists of a flexible material serves as a seal with respect to a likewise preferably flexible, vertical sealing strip 7. It is plugged through a through opening 50 of the cover. If it additionally penetrates into the second mounting groove 42, it serves at the same time to fasten the cover. If it is of flat or depressed configuration with respect to the cover 5, it serves merely for fastening. This can be seen clearly in FIG. 7.

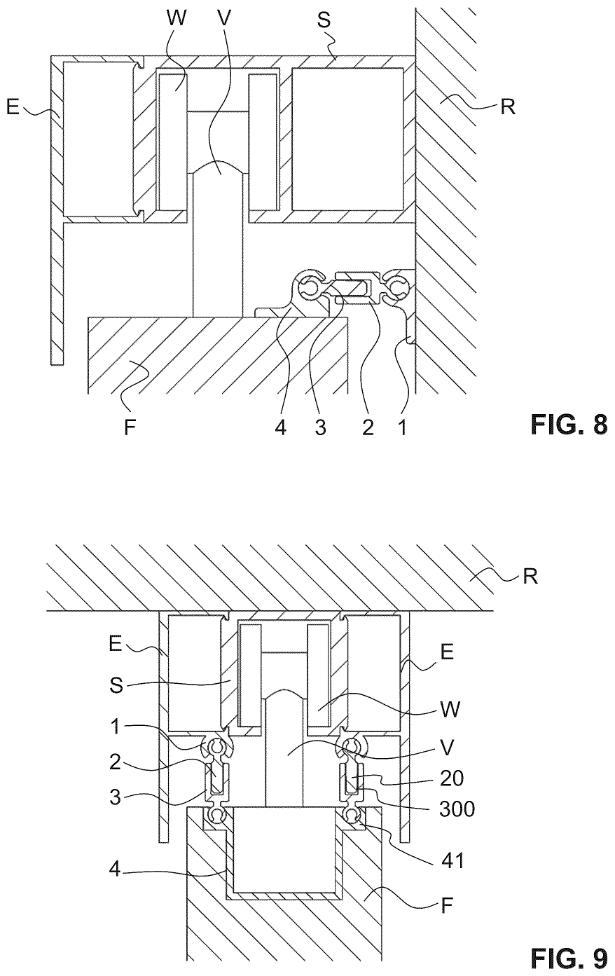

FIG. 8 shows a further embodiment of the sliding door seal according to the invention. The stationary first receiving part 1 is of identical configuration to the above-described second receiving part 4. It can therefore be used for fastening to a stationary vertical surface, which here is the door frame R. The displaceable second receiving part 4 is of identical configuration to that which has already been described. It is now fastened, however, on the upper horizontal surface of the sliding door wing F. The first and the second sealing strip 2, 3 are unchanged. As a result of this configuration and arrangement, the top gap between the door wing F and the running rail S is still sealed, but in the horizontal direction.

As can be seen by comparing the embodiments according to FIGS. 3 to 7 and 8, different arrangements can therefore be obtained with the same components. Depending on the embodiment and configuration of the first and second mounting groove 12, 42, the first or the second sealing strip 2, 3 is mounted in the associated mounting groove 12, 42 such that it can be displaced in the longitudinal direction of the strips, wherein the other sealing strip 2, 3 is mounted in the associated mounting groove 12, 42 non-displaceably in the longitudinal direction. In other embodiments, the first sealing strip 2 extends over the entire length of the running rail, wherein it is connected non-displaceably to the first receiving part 1. The second sealing strip 3 can be displaced in a guided manner in the longitudinal direction relative to the first sealing strip 2, wherein it is preferably, furthermore, mounted in a floating manner in the transverse direction Q, in order to compensate for floor adaptations of the door wing.

Two sliding door seals which share a common second receiving part 4 can be seen in FIG. 9. The second receiving part is configured as a U-shaped profile rail which is arranged in an upper groove of the door wing F. The U-shaped profile rail forms a large U-shaped groove for fastening the suspension means V and, at the free ends of its two limbs, it in each case has a smaller U-shaped groove which is likewise of upwardly open configuration.

These two smaller grooves form the second mounting grooves 42 for receiving the second sealing strip 3. In this example, the second sealing strip 3 is provided with a U-shaped receiving groove 300, and the sealing body 20 of the first sealing strip 2 is a groove block with a rectangular cross section.

The first receiving part 1 is of integral configuration with a stationary part of the sliding door. In this case, it is a panel E which is connected releasably to the running rail S.

Depending on the configuration of the mounting grooves 12, 42 of the two receiving parts 1, 4, one or the other of the two sealing strips 2, 3 is mounted such that it can be displaced in the longitudinal direction or such that it cannot be displaced in the longitudinal direction. At least one sealing strip 2, 3, preferably the two sealing strips 2, 3, is/are preferably mounted such that it/they can be swivelled, however.

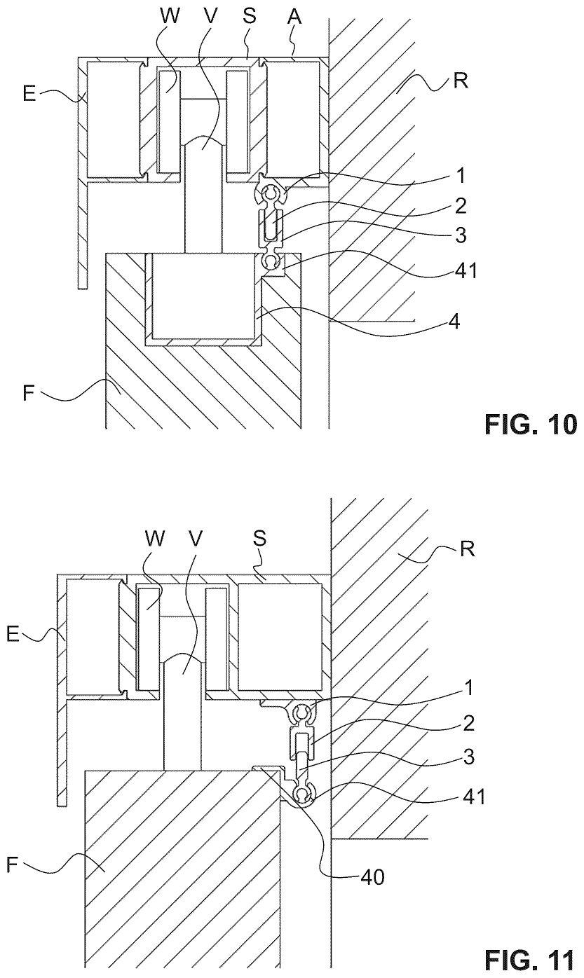

FIG. 10 shows a further exemplary embodiment. The running rail S is connected on one longitudinal side to a panel E, and there is a wall adapter A on the other longitudinal side.

The wall adapter has the first receiving part 1 as an integral constituent part. The second receiving part 4 is in turn configured as a smaller groove of an insert element which is inserted into an upper groove of the door wing F.

In FIG. 11, the running rail S itself bears against the door frame R. The first receiving part 1 is of identical configuration to that in the first exemplary embodiment according to FIGS. 3 to 7. The second receiving part 4 has an angled base plate 40, with the result that it can be fastened to one edge of the door wing F on two sides of the door wing F.

It can be seen by comparing the preceding examples with FIG. 11 that the floating mounting of the first and/or the second sealing strip 2, 3 enables a high adaptation capability of the sliding door seal in the direction perpendicular to its longitudinal direction and parallel to the transverse direction, and therefore permits an increased adaptation capability in the horizontal or in the vertical direction of the sliding door depending on the installation type. If, in addition, there is/are one or two additional swivel capabilities, there is a very high degree of adaptation capability and flexibility.

The sliding door seal according to the invention can be used in a versatile manner and enables friction-free and low-noise actuation of the sliding door.

1. A sliding door seal for sealing a door gap of a sliding door,
wherein the sliding door has a first seal part for fastening to a stationary element of the sliding door and a second seal part for fastening to a displaceable door wing of the sliding door,
wherein the first seal part and the second seal part run parallel to one another and define a longitudinal direction, and
wherein the first seal part and the second seal part together form a barrier, in order to close the door gap which is formed between the stationary element and the displaceable door wing,
wherein the barrier defines a transverse direction which runs perpendicularly with respect to the longitudinal direction,
wherein the barrier has at least one self-aligning or self-compensating element which is held movably in a bearing in a guided manner.

2. The sliding door seal according to claim 1, wherein the at least one self-aligning element is a first and/or a second sealing strip which runs parallel to the longitudinal direction.

3. The sliding door seal according to claim 2, wherein the first or the second seal strip is mounted in the other sealing strip in a floating manner in a direction parallel to the transverse direction and/or parallel to the longitudinal direction.

4. The sliding door seal according to claim 2, wherein the first and the second sealing strip are connected to one another non-displaceably in the longitudinal direction, and
a) wherein the first and the second sealing strip are together a constituent part of the second seal part,
or
b) wherein they are together a constituent part of the first seal part.

5. Sliding door seal according to claim 2, wherein the first and the second sealing strip are connected to one another displaceably in the longitudinal direction, and
wherein the first or the second sealing strip is a constituent part of the first seal part, and the other sealing strip is a constituent part of the second seal part.

6. The sliding door seal according to claim 5, wherein the first or the second seal strip has a receiving groove running in the longitudinal direction with a U-shaped or C-shaped cross section, and the other seal strip has a counterpiece running in the longitudinal direction with a matching cross section, wherein the counterpiece is mounted in the groove in a floating manner in the transverse direction.

7. The sliding door seal according to claim 2, wherein the first sealing strip and the second sealing strip are of stiff or rigid configuration.

8. The sliding door seal according to claim 2, wherein the first and/or the second sealing strip can be swivelled about an axis which runs parallel to the longitudinal direction.

9. The sliding door seal according to claim 8, wherein the at least one swivellable sealing strip has a swivel body which extends over its entire length, wherein the swivel body has a round cross section.

10. The sliding door seal according to claim 2, wherein the first seal part has a first receiving part, wherein the first sealing strip is held in the first receiving part, and/or wherein the second seal part has a second receiving part, wherein the second sealing strip is held in the second receiving part.

11. The sliding door seal according to claim 10, wherein the first sealing strip can be positionally changed relative to the first receiving part, and/or wherein the second sealing strip can be positionally changed relative to the second receiving part.

12. The sliding door seal according to claim 11, wherein the first sealing strip and/or the second sealing strip are/is mounted in the first and in the second receiving part such that they/it can be swivelled about an axis parallel to the longitudinal direction.

13. The sliding door seal according to claim 10, wherein the first receiving part has a first connecting body with a first mounting groove for receiving the first sealing strip, and/or wherein the second receiving part has a second connecting body with a second mounting groove for receiving the second sealing strip.

14. The sliding door seal according to claim 9, wherein the first and/or the second receiving part have/has a base plate for fastening to one of the stated components of the sliding door.

15. A sliding door arrangement with a sliding door and a sliding door seal according to claim 1, wherein the first sealing strip of the sliding door seal is fastened indirectly or directly to a running rail, a door frame, a wall adapter, a panel or a building wall of the sliding door.

16. The sliding door seal according to claim 1 wherein the sliding door seal is for sealing a top door gap of a sliding door.

17. The sliding door seal according to claim 6, wherein the first or the second seal strip has a receiving groove running in the longitudinal direction with a U-shaped or C-shaped cross section, and the other seal strip has a counterpiece running in the longitudinal direction with a matching cross section, wherein the counterpiece is mounted in the groove in a floating manner in the transverse direction.

18. The sliding door seal according to claim 10, wherein the first and/or the second receiving part have/has a base plate for fastening to one of the stated components of the sliding door.
